(19) United States
(12) Patent Application Publication
(10) Pub. No.: US 2007/0217087 A1
(43) Pub. Date: Sep. 20, 2007

(54) Magnetic thin film and magnetoresistance effect element having a heusler alloy layer containing an additive element

(75) Inventors: Kei Hirata, Tokyo (JP); Keita Kawamori, Tokyo (JP); Tomohito Mizuno, Tokyo (JP); Yoshihiro Tsuchiya, Tokyo (JP); Koji Shimazawa, Tokyo (JP)

Correspondence Address: FITCH, EVEN, TABIN & FLANNERY, P. O. BOX 18415, WASHINGTON, DC, 20036, US

(73) Assignee: TDK Corporation, Tokyo (JP)

(21) Appl. No.: 11/723,143

(22) Filed: Mar. 16, 2007

(30) Foreign Application Priority Data
Mar. 17, 2006 (JP) 2006-074521

(51) Int. Cl. G11B 5/127; G11B 5/33

(52) U.S. Cl. 360/324.12; 360/313

(57) ABSTRACT

A magnetic thin film has a layer which is formed of an alloy having a ordered crystal structure whose composition formula is represented by XYZ or X₂YZ (where X is one or more than one of the elements selected from the group consisting of Co, Ir, Rh, Pt, and Cu, Y is one or more than one of the elements selected from the group consisting of V, Cr, Mn, and Fe, and Z is one or more than one of the elements selected the group consisting of Al, Si, Ge, As, Sb, Bi, In, Ti, and Pb). The alloy contains at least one additive element which is not included in the composition formula of the alloy and which has a Debye temperature that is equal to or less than 300K.

The present application is based on, and claims priority from, J.P. Application No. 2006-74521, filed on Mar. 17, 2006, the disclosure of which is hereby incorporated by reference herein in its entirety.

### BACKGROUND OF THE INVENTION

1. Field of the Invention

The present invention relates to a magnetic thin film. The present invention also relates to a magnetoresistance element and a thin-film magnetic head that utilize the same.

2. Description of the Related Art

A magnetic thin film is used as a ferromagnetic layer of a magnetoresistance element (MR element). A magnetoresistance element is widely used, for example, as a read head portion in a thin-film magnetic head that is used for a hard disk device, and as a memory cell in a magnetic memory. In recent years, the recording density of a hard disk device and a magnetic memory has been increasing. Accordingly, higher sensitivity and higher output have been required for the magnetoresistance element.

In order to meet this requirement, a magnetoresistance element which utilizes a spin valve film (SV film) has been developed. A spin valve film has a pinned layer whose magnetization direction is fixed, a free layer whose magnetization direction changes in accordance with an external magnetic field, and a non-magnetic spacer layer that is disposed therebetween. The pinned layer and the free layer are formed of ferromagnetic layers. The magnetization direction of the pinned layer is fixed by an antiferromagnetic layer which is disposed under the pinned layer. In addition to a pinned layer having a single-layer structure, a pinned layer having a three-layer structure for forming a synthetic SV film has also been developed recently. This pinned layer consists of a ferromagnetic layer, a non-magnetic metal layer, and another ferromagnetic layer. In a synthetic SV film, strong exchange coupling is produced between the two ferromagnetic layers, and thus, exchange-coupling force that is produced by the antiferromagnetic layer is effectively increased.

Additionally, in order to enhance output power, a CPP (Current Perpendicular to Plane) magnetoresistance element, in which sense current flows perpendicularly to layer surfaces, has also been proposed. In a CPP magnetoresistance element, a large polarizability is required for ferromagnetic layers. A large polarizability serves to enhance a magnetoresistance ratio (also referred to as a MR ratio), which is an index indicating the sensitivity of the magnetoresistance element. Heusler alloy is known as a material which presents half-metal-like characteristics, e.g., a large spin-polarizability. Japanese Patent Laid-Open Publication No. 2005-116703 discloses a magnetoresistance element in which both the pinned layer and the free layer, the pinned layer, or the free layer is formed of a Heusler-alloy layer, whose composition formula is represented by X₂YZ or XYZ (where X is one or more elements selected from the group consisting of Cu, Co, Ni, Rh, Pt, Au, Pd, Ir, Ru, Ag, Zn, Cd, and Fe; Y is one or more elements selected from the group consisting of Mn, Fe, Ti, V, Zr, Nb, Hf, Ta, Cr, Co, and Ni; and Z is one or more elements selected from the group consisting of Al, Sn, In, Sb, Ga, Si, Ge, Pb, and Zn).

In order to obtain a large polarizability for a Heusler-alloy layer, it is significantly important that the Heusler-alloy layer has a specific crystal structure (L21 or B2 structure) in which atoms are arranged in specific positions in the lattice. In other words, the Heusler-alloy layer has to be regulated or has to be formed as an ordered lattice. In this specification, “regularization” means a process to put the Heusler-alloy in the state of an ordered lattice, or in the state of an ordered crystal structure. In general, a Heusler-alloy layer is not put in the state of a specific crystal structure just by depositing it at room temperature by means of, for example, sputtering. In order to regulate the Heusler-alloy layer, it is necessary to increase the temperature of the substrate during deposition, or to apply heat treatment (also referred to as “regularizing treatment”), such as annealing, to the Heusler-alloy layer that has been deposited.

However, high temperature treatment for regularizing the Heusler-alloy layer is disadvantageous in the following respects.

For example, if a higher substrate temperature is required during deposition in the fabrication process of a magnetoresistance element, then a longer time will be needed until the required substrate temperature is obtained. As a result, production efficiency for the magnetoresistance element is lowered. Additionally, the layer surface becomes slightly uneven, and the unevenness is duplicated in successive layers which are subsequently deposited. This phenomenon may cause the emergence of the interlayer magnetic coupling field between the pinned layer and the free layer due to the “orange peel effect”. In addition, in a CPP magnetoresistance element, a conductive metal layer, which has a function of a magnetic shield and an electrode, is provided under the magnetoresistance element. The high temperature for regularizing the magnetoresistance element may cause an increase in the diameters of crystal particles in the magnetic shield layer which is formed prior to the magnetoresistance element in the fabrication process. This phenomenon may lower the magnetic permeability of the magnetic shield layer, and thus, may deteriorate the reproductive characteristics of the magnetoresistance element that is used in a thin-film magnetic head.

### SUMMARY OF THE INVENTION

The object of the present invention is to provide a magnetic thin film and a magnetoresistance element in which the Heusler alloy can be regulated at a low temperature, and accordingly in which the crystal structure is well-regularized and the disadvantages that may be caused by the high temperature process are mitigated.

According to an embodiment of the present invention, a magnetic thin film comprises a layer which is formed of an alloy having a ordered crystal structure whose composition formula is represented by XYZ or X₂YZ (where X is one or more than one of the elements selected from the group consisting of Co, Ir, Rh, Pt, and Cu, Y is one or more than one of the elements selected from the group consisting of V, Cr, Mn, and Fe, and Z is one or more than one of the elements selected the group consisting of Al, Si, Ge, As, Sb, Bi, In, Ti, and Pb). The alloy contains at least one additive element which is not included in the composition formula of the alloy and which has a Debye temperature that is equal to or less than 300K.

The amount of the additive element is preferably between 2 to 20 atomic % relative to said alloy.

The additive element is preferably selected from the group consisting of As, Se, Y, Zr, Nb, Pd, Ag, Cd, In, Sn, Sb, Hf, Ta, Pt, Au, Hg, TI, Pb, Bi, and La.

According to another embodiment of the present invention, a magnetoresistance element comprises: a pinned layer whose magnetization direction is fixed; a free layer whose magnetization direction changes in accordance with an external magnetic field; and a non-magnetic spacer layer which is provided between said pinned layer and said free layer. At least either of the pinned layer or the free layer includes the above-described magnetic thin film.

Therefore, the internal energy of the alloy is increased compared with a case in which an additive element is not added. Accordingly, the movement of atoms for regularization is promoted during heat treatment, and thereby regularization is performed at a lower temperature compared with a case in which an additive element is not added.

The additive element is preferably selected from the group consisting of Au, Ag, Pd, and Nb.

The pinned layer may have two ferromagnetic layers and a non-magnetic intermediate layer which is sandwiched therebetween.

According to another embodiment of the present invention, a magnetic memory element comprises: a plurality of the above-described magnetoresistance elements; and a wiring unit which is connected to the plurality of magnetoresistance elements. The wiring unit is adapted to selectively write information in any one of the magnetoresistance elements or to selectively read information from any one of the magnetoresistance elements.

According to the present invention, an additive element having a Debye temperature that is equal to or less than 300K is added to an alloy whose composition formula is represented by XYZ or X₂YZ. Accordingly, a magnetic thin film obtains half-metal-like characteristics through the regularizing treatment that is performed at a temperature lower than that in prior art. As a result, a magnetoresistance element according to the present invention, which includes a magnetic thin film according to the present invention, can exhibit a large MR ratio while overcoming disadvantages that may be caused by the regularizing treatment that is performed at a high temperature.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a cross-sectional view illustrating the main portions of a thin-film magnetic head according to an embodiment of the present invention;

FIG. 2 is a view of the MR element illustrated in FIG. 1, viewed from the side of the air bearing surface;

FIG. 3A is a schematic diagram illustrating the arrangement of elements when a Heusler alloy has the L21 structure;

FIG. 3B is a schematic diagram illustrating the arrangement of elements when a Heusler alloy has the B2 structure;

FIG. 4 is a graph showing the relationship between the amount of the additive Ag and the saturation magnetization Ms of a magnetic thin film produced in Experiment 1, when the magnetic thin film is annealed at 300° C.;

FIG. 5 is a graph showing the relationship between the amount of the additive Ag and the saturation magnetization Ms of a magnetic thin film produced in Experiment 1, when the magnetic thin film is annealed at 320° C.;

FIG. 6 is a graph showing the relationship between the amount of the additive Ag and the saturation magnetization Ms of a magnetic thin film produced in Experiment 1, when the magnetic thin film is annealed at 350° C.;

FIG. 7 is a graph showing the relationship between the film thickness and the saturation magnetization Ms of a magnetic thin film produced in Experiment 2, when the amount of the additive Ag is 10 atomic %;

FIG. 8 is a graph showing the relationship between the film thickness and the saturation magnetization Ms of a magnetic thin film produced in Experiment 2, when the amount of the additive Ag is 15 atomic %;

FIG. 9 is a graph showing the relationship between the Debye temperature of the additive element and the regularization initiating temperature of a magnetic thin film produced in Experiment 3.

FIG. 10 is an exemplary plan view of a wafer on which the thin-film magnetic heads illustrated in FIG. 1 are formed;

FIG. 11 is an exemplary perspective view of a slider that includes the thin-film magnetic head illustrated in FIG. 1;

FIG. 12 is a perspective view of a head gimbal assembly that includes the slider illustrated in FIG. 10;

FIG. 13 is a diagram showing the essential parts of a hard disk drive that includes the head gimbal assembly illustrated in FIG. 12; and

FIG. 14 is a plan view of a hard disk drive that includes the head gimbal assembly illustrated in FIG. 12.

### DETAILED DESCRIPTION OF THE PREFERRED EMBODIMENTS

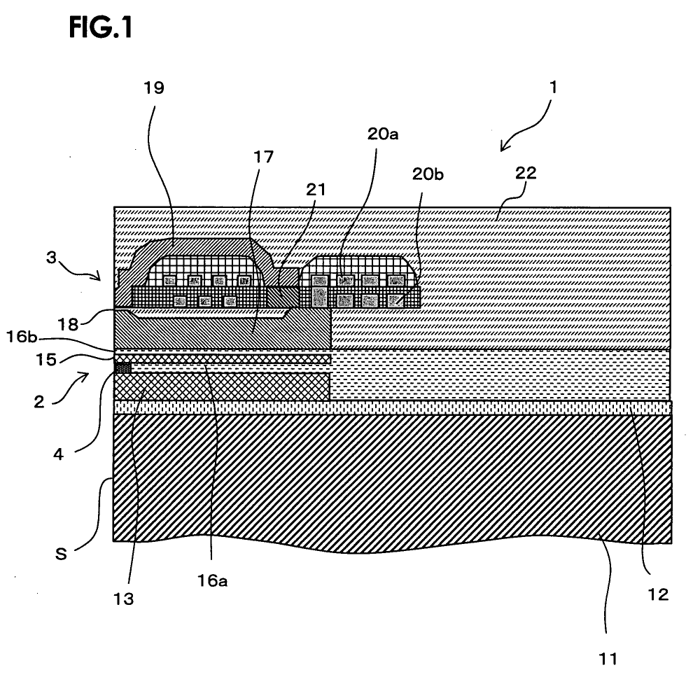

FIG. 1 is a cross-sectional view conceptually illustrating the main portions of a thin-film magnetic head according to an embodiment of the present invention.

Thin-film magnetic head 1 according to the present embodiment has substrate 11, read head portion 2 for reading information from a recording medium, not shown, and write head portion 3 for writing information on a recording medium. These portions 2, 3 are formed on substrate 11.

Substrate 11 is made of Al₂O₃.TiC (ALTiC) that has high abrasion resistance. Seed layer 12, which is made of alumina, is formed on substrate 11. Read head portion 2 and write head portion 3 are formed on seed layer 12.

Lower shield layer 13, which is made of a magnetic material, such as perm-alloy (NiFe), is formed on seed layer 12. MR element 4 is formed on lower shield layer 13 on the side of air bearing surface S such that one end portion thereof is exposed at air bearing surface S. First upper shield layer 15, which is made of a magnetic material, such as perm-alloy, is formed on MR element 4. Lower shield layer 13, MR element 4, and first upper shield layer 15 together constitute read head portion 2. The space between lower shield layer 13 and first upper shield layer 15, except for MR element 4, is filled with insulating layer 16a.

Lower magnetic pole layer 17, which is made of a magnetic material, such as a perm-alloy or CoNiFe, is formed on first upper shield layer 15, with insulating layer 16b sandwiched therebetween.

Upper magnetic pole layer 19 is formed on lower magnetic pole layer 17, with recording gap layer 18 formed therebetween. Recording gap layer 18 is made of a non-magnetic material, such as Ru or alumina, and is formed on the side of air bearing surface S of thin-film magnetic head 1 such that one end thereof is exposed at air bearing surface S. Upper magnetic pole layer 19 is formed of a magnetic material, such as a perm-alloy or CoNiFe. Lower magnetic pole layer 17 and upper magnetic pole layer 19 are magnetically coupled with each other via connecting portion 21 so as to form a magnetic circuit as a whole.

Coils 20a, 20b, which are made of a conductive material, such as copper, are formed in two layers between lower magnetic pole layer 17 and upper magnetic pole layer 19 and between air bearing surface S and connecting portion 21. Coils 20a, 20b are provided to supply a magnetic flux to lower magnetic pole layer 17 and upper magnetic pole layer 19. Each coil extends around connecting portion 21 such that it forms a planar spiral. Coils 20a, 20b are insulated from the surroundings by insulating layers. Although the coils are provided in two layers in the present embodiment, the number of layers is not limited to two. A single layer structure or a layer structure that consists of more than two layers may also provided.

Overcoat layer 22 is provided over upper magnetic pole layer 19, and protects the layers which are formed under overcoat layer 22. Overcoat layer 22 is formed of an insulating material, such as alumina.

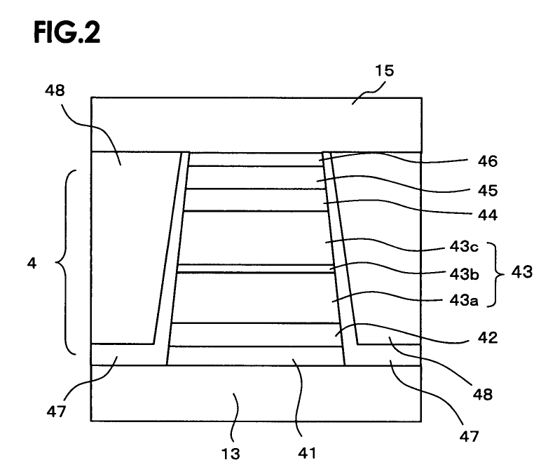

Next, with reference to FIG. 2, which is the view of MR element 4 illustrated in FIG. 1, viewed from the side of air bearing surface S, MR element 4 will be explained in detail.

MR element 4 is disposed between lower shield layer 13 and upper shield layer 15, as described above. MR element 4 has buffer layer 41, antiferromagnetic layer 42, pinned layer 43, spacer layer 44, free layer 45, and cap layer 46, which are stacked in this order starting from lower shield layer 13. In the present exemplary embodiment, pinned layer 43 has outer layer 43a, inner layer 43c, and non-magnetic intermediate layer 43b disposed therebetween. Outer layer 43a and inner layer 43c are both made of a ferromagnetic material. This type of a pinned layer is called the synthetic pinned layer. Outer layer 43a is provided adjacent to antiferromagnetic layer 42, and inner layer 43c is provided adjacent to spacer layer 44.

Lower shield layer 13 and upper shield layer 15 also serve as electrodes. Sense current is applied to MR element 4 in a direction that is perpendicular to the layer surfaces via lower shield layer 13 and upper shield layer 15.

Buffer layer 41 is formed of a material which facilitates exchange coupling between antiferromagnetic layer 42 and outer layer 43a of pinned layer 43, and may be formed, for example, as stacked layers of Ta/NiCr, Ta/Ru, or Ta/NiFe. Antiferromagnetic layer 42 serves to fix the magnetization direction of pinned layer 43, and is formed of, for example, IrMn, PtMn, RuRnMn, or NiMn.

Pinned layer 43 is formed as a magnetic layer, and has outer layer 43a, non-magnetic intermediate layer 43b, and inner layer 43c, which are stacked in this order, as described above. The magnetization direction of outer layer 43a is fixed relative to an external magnetic field by antiferromagnetic layer 42. Outer layer 43a is formed of stacked layers, such as CoFe/FeCo/CoFe. Non-magnetic intermediate layer 43b is formed of, for example, Ru. Inner layer 43c is formed of a magnetic material, such as CoFe or NiFe, and may be formed either as a single layer structure or as a multi layer structure. In the synthetic pinned layer, the magnetization direction of inner layer 43c is firmly fixed, and since the magnetic moments of outer layer 43a and inner layer 43c mutually cancel each other out, the overall leakage of magnetic field is limited.

Spacer layer 44 is made of a non-magnetic material, such as Cu, Au, Ag, or Cr, and is preferably made of Cu.

Free layer 45 is formed of a magnetic material, and the magnetization direction thereof changes in accordance with an external magnetic field. In the present embodiment, free layer 45 has a layer that is made of the Heusler alloy. Free layer 45 may also include a layer which is made of a material that is commonly used as a ferromagnetic layer, such as CoFe or NiFe, which is disposed over or under the Heusler alloy layer. The Heusler alloy layer may be disposed adjacent to spacer layer 44.

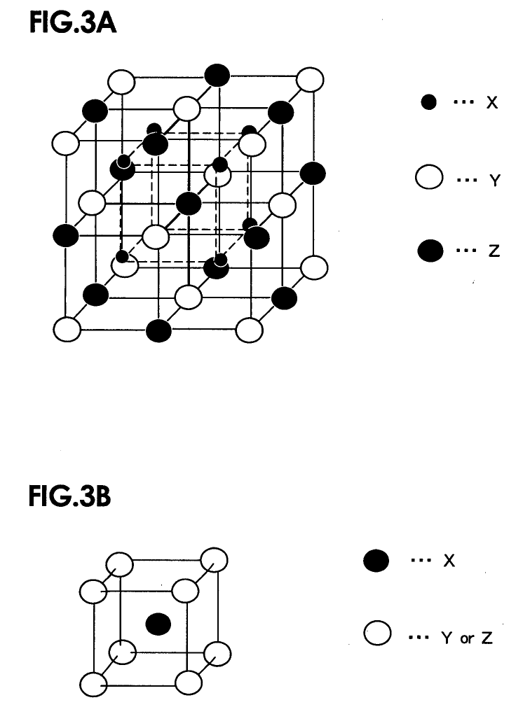

The Heusler alloy that is used in the present embodiment is an alloy whose composition formula is represented by X₂YZ or XYZ, wherein the element in the X site is one or more than one of the elements that are selected from the group consisting of Co, Ir, Rh, Pt, and Cu, the element in the Y site is one or more than one of the elements that are selected from the group consisting of V, Cr, Mn, and Fe, and the element in the Z site is one or more than one of the elements that are selected from the group consisting of Al, Si, Ge, As, Sb, Bi, In, Ti, and Pb. The Heusler alloy can be formed in a crystal structure, such as the L21 structure illustrated in FIG. 3A, or the B2 structure illustrated in FIG. 3B. The Heusler alloy exhibits a large polarizability when it has one of these crystal structures. It is not possible to form the Heusler alloy in the L21 or B2 structure only by depositing the layer. However, the Heusler alloy is formed in the L21 or B2 structure by being regularized through heat treatment, such as annealing.

The Heusler alloy layer may be included both in inner layer 43 and in free layer 45. Alternatively, the Heusler alloy layer may be included in inner layer 43c alone. If the Heusler alloy layer is included in inner layer 43c, then inner layer 43c may be formed of the Heusler alloy alone, or may be formed in a stacked structure consisting of the Heusler alloy layer and a layer that is made of CoFe or NiFe.

Cap layer 46 is provided to prevent the deterioration of MR element 4. Cap layer 46 is formed of, for example, Ru.

Hard bias layers 48 are provided on both sides of MR element 4 with regard to the track width direction. Insulating layer 47 is formed between MR element 4 and corresponding hard bias layer 48. The track width direction means the in-plane direction of each layer that constitutes MR element 4 in a plane that is parallel to air bearing surface S (see FIG. 1). Hard bias layers 48 apply a bias magnetic field to free layer 45 in the track width direction in order to put free layer 45 in a single-domain state. Hard bias layers 48 are formed of a hard magnetic material, such as a CoPt or CoCrPt. Insulating layers 47, which are provided to prevent sense current from leaking to hard bias layers 48, may be formed of an oxide film, such as an Al₂O₃ film.

In the exemplary explanation described above, pinned layer 43 is a synthetic pinned layer. However, pinned layer 43 may also be formed of magnetic material alone, such as CoFe or NiFe. Alternatively, pinned layer 43 may be formed of the Heusler alloy alone, or may be formed of stacked layers consisting of the Heusler alloy and a magnetic material.

Next, the most characterizing feature of the present embodiment will be explained. The most characterizing feature of the present embodiment is that the Heusler-alloy layer that is included in free layer 45 and/or pinned layer 43 contains an additive element that is different from the elements that constitute X, Y, and Z that are mentioned above.

The additive element that is included in the Heusler-alloy layer is a metallic element whose Debye temperature is equal to or less than 300K. The following relationship is known between the Debye temperature and the lattice specific heat of a metallic element, as represented below by Equations (1) and (2).

$$\begin{matrix}{C}_{v} = α {T}^{3} & Equation ( 1 ) \\ α = \frac{12 {π}^{4} {Nk}_{B}}{5 {θ}^{3}} & Equation ( 2 )\end{matrix}$$

In Equations (1) and (2), Cv, T, N, k_{B}, and θ denote the lattice specific heat, the temperature of solid, the number of atoms, the Boltzmann constant, and the Debye temperature, respectively. It can be understood from Equations (1) and (2) that if the Debye temperature is low, then the lattice specific heat is large.

The Heusler-alloy layer is in an amorphous state, having a disordered structure in which each element is irregularly arranged after film deposition has been carried out and when regularizing treatment has not been performed. Accordingly, if an element having a low Debye temperature, i.e., a high lattice specific heat, is added to the elements that constitute the Heusler-alloy layer, then the specific heat (internal energy) of the entire Heusler-alloy layer will be increased. The alloy layer in an amorphous state is converted into an ordered or regulated state, i.e., the state of the L21 or B2 structure, by being heated. Since the specific heat of the entire Heusler-alloy layer is increased by the additive element, the movement of atoms is promoted during heat treatment (regularizing treatment). Consequently, conversion to the ordered state is facilitated at a lower temperature, compared with a case in which no additive element is added. The inventors think that the additive element remains in the lattice in a state in which the element in Y site is replaced by the additive element after regularization.

Because regularization is promoted, most portions of the Heusler-alloy layer are formed in the state of the L21 or B2 structure, and the Heusler-alloy layer works as a magnetic thin film having half-metal-like characteristics. When the Heusler-alloy layer has the L21 structure, the crystal of the Heusler alloy indicates a preferential orientation of (220) plane, and has a lattice constant between 0.55 and 0.58 nm. When the Heusler-alloy layer has the B2 structure, the crystal of the Heusler alloy shows a preferential orientation of (110) plane, and has a lattice constant between 0.275 to 0.29 nm.

The Heusler-alloy layer described above exhibits a large polarizability, and MR element 4 thus exhibits a large MR ratio. Additionally, the amount of time needed to produce MR element 4, as well as the amount of time needed to form a regularized Heusler-alloy layer, can be shortened because of the low temperature at which the Heusler-alloy layer will be regularized. Moreover, various disadvantages that may be caused by the high temperature, at which regularization of the Heusler-alloy layer occurs, can be mitigated because of the low temperature treatment. The disadvantages that may be caused by the high temperature include, (1) generation of an interlayer-coupling magnetic field between inner layer 43c and free layer 45 which is caused by the unevenness of the layer surface, and (2) an increase in the diameters of crystal particles in the layers that are formed prior to the Heusler-alloy layer. The effect of the low temperature treatment for the regularization can be achieved by adding a metallic element to the Heusler-alloy layer, and particularly, by adding a metallic element having the Debye temperature that is equal to or less than 300K.

The additive element that is able to lower the temperature for the regularization of the Heusler alloy includes, for example, As, Se, Y, Zr, Nb, Pd, Ag, Cd, In, Sn, Sb, Hf, Ta, Pt, Au, Hg, TI, Pb, Bi, and La. In particular, Au, Ag, Pd, and Nb are preferable. The above-described effect can be achieved even if an extremely small amount of the additive element is added. However, the preferable amount of the additive element is between 2 atomic % and 20 atomic %.

The above-described MR element 4 can be produced in a manner described below.

Buffer layer 41, antiferromagnetic layer 42, outer layer 43a, non-magnetic intermediate layer 43b, inner layer 43c, and spacer layer 44 are sequentially formed on lower shield layer 13. Next, free layer 45 and cap layer 46 are sequentially formed on spacer layer 44. These layers can be formed according to a prior art deposition process for a conventional MR element, such as sputtering. After formation of cap layer 46, annealing is performed so that the Heusler alloy that is included in free layer 45 is formed in the L21 or B2 structure. If inner layer 43c includes the Heusler alloy, then the Heusler alloy that is included in inner layer 43c is also formed in the L21 or B2 structure through annealing. Since the layer that includes the Heusler alloy is regularized at a temperature lower than the conventional temperature due to the additive element that is added to the Heusler alloy, annealing can be performed at a temperature compared with the temperature for conventional annealing.

In order to confirm the effects of the additive element that is added to the Heusler-alloy layer, experiments described below were carried out.

### (Experiment 1)

In Experiment 1, an alloy layer that contains CoMnSi as a base material and Ag as an additive element was formed on a substrate, and the alloy layer was regularized through annealing in order to produce a magnetic thin film having the L21 or B2 structure. Magnetic thin films were produced and the degree of regularization was measured for various amounts of the additive Ag that was added to the base material and for various annealing temperatures. The film thickness of the magnetic thin film was 80 nm. The degree of regularization after annealing was evaluated based on the saturation magnetization Ms (A/m) of the magnetic thin film and the diffraction intensity of X-rays on (110) plane or on (220) plane after regularization.

A CoMnSi alloy is completely regularized through annealing at 400° C., and has the saturation magnetization Ms of approximately 850(×10³ A/m) after annealing at 400° C. The degree of regularization of the magnetic thin film can be evaluated by comparing this value with the values of Ms that are obtained for the magnetic thin films. The diffraction intensity of X-rays of the magnetic thin film was evaluated based on the ratio between the diffraction intensity of the magnetic thin film and that of CoMnSi alloy that is completely regularized through annealing at 400° C.

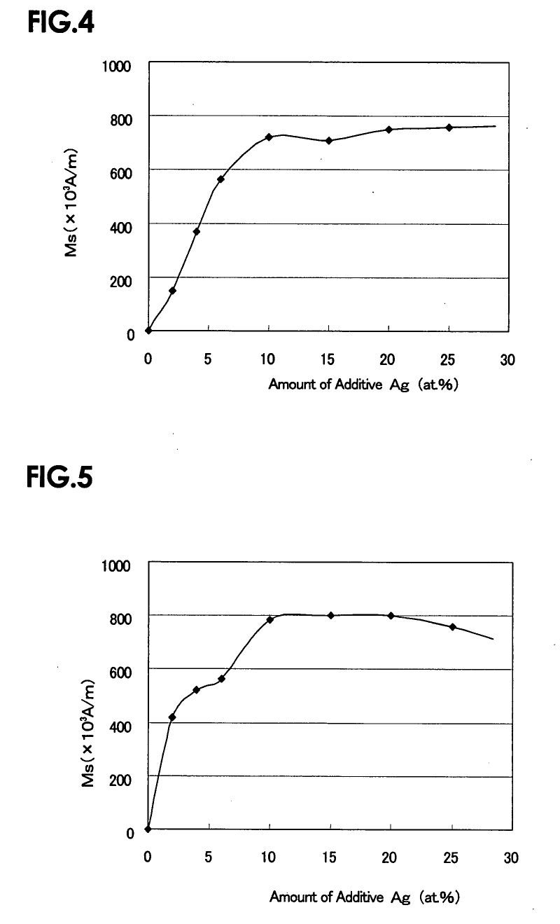

Table 1 shows the saturation magnetization Ms and the diffraction intensity of X-rays for magnetic thin films having various amounts (atomic %) of the additive Ag that were produced through annealing at 300° C. FIG. 4 shows a graph that illustrates the relationship between the amount of the additive Ag and the saturation magnetization Ms.

TABLE 1
(Annealing temperature: 300° C.)

| Amount of | Saturation | |
|---|---|---|
| additive Ag | magnetization Ms | Diffraction intensity of X-rays on |
| (atomic %) | (×10³ A/m) | (110) plane or (220) plane |
| 0 | 0 | 0 |
| 2 | 150 | 0.25 |
| 4 | 371 | 0.55 |
| 6 | 564 | 0.62 |
| 10 | 722 | 0.90 |
| 15 | 710 | 0.93 |
| 20 | 752 | 0.96 |
| 25 | 761 | 1 |

Table 2 and FIG. 5 show the results for magnetic thin films that were annealed at 320° C.

TABLE 2
(Annealing temperature: 320° C.)

| Amount of | Saturation | |
|---|---|---|
| additive Ag | magnetization Ms | Diffraction intensity of X-rays on |
| (atomic %) | (×10³ A/m) | (110) plane or (220) plane |
| 0 | 0 | 0 |
| 2 | 420 | 0.54 |
| 4 | 521 | 0.61 |
| 6 | 564 | 0.66 |
| 10 | 786 | 0.94 |
| 15 | 799 | 0.95 |
| 20 | 802 | 1 |
| 25 | 758 | 1 |

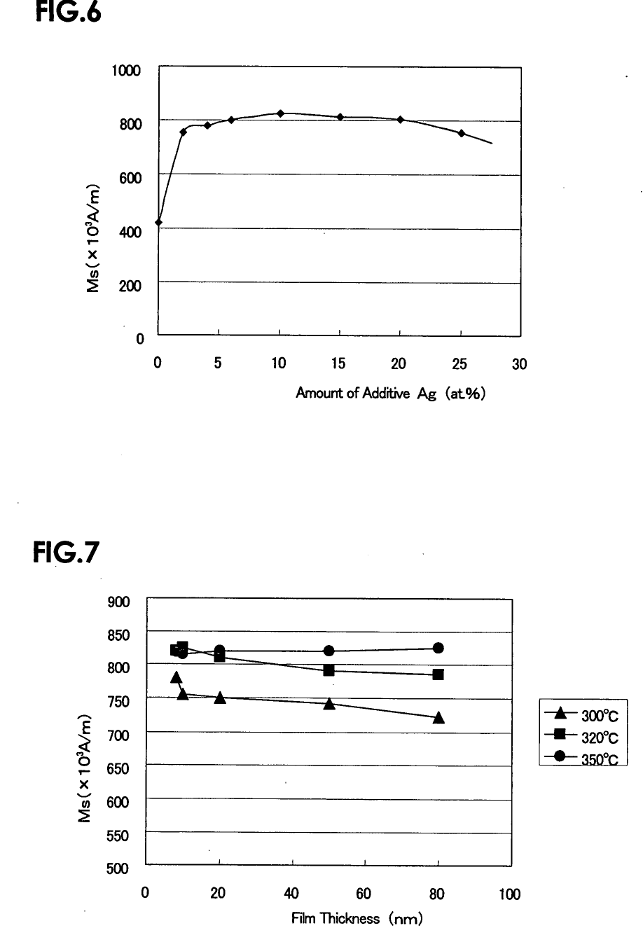

Table 3 and FIG. 6 show the results for magnetic thin films that were annealed at 350° C.

TABLE 3
(Annealing temperature: 350° C.)

| Amount of | Saturation | |
|---|---|---|
| additive Ag | magnetization Ms | Diffraction intensity of X-rays on |
| (atomic %) | (× 10³ A/m) | (110) plane or (220) plane |
| 0 | 421 | 0.42 |
| 2 | 755 | 0.82 |
| 4 | 782 | 0.85 |
| 6 | 801 | 1 |
| 10 | 825 | 1 |
| 15 | 812 | 1 |
| 20 | 805 | 1 |
| 25 | 754 | 1 |

It can be understood from these results that if Ag is not added, then the magnetic thin film will not be regularized at all when the annealing temperature is 300° C. or 320° C., and only half the magnetic thin film will be regularized when the annealing temperature is 350° C. It is understood that regularization progresses more fully in accordance with the amount of the additive Ag under the same temperature condition, although the saturation magnetization Ms is slightly decreased when the amount of the additive Ag is 25 atomic % and the annealing temperature is 320° C. and 350° C. Also, judging from the diffraction intensity of X-rays, it is understood that regularization progresses more fully in accordance with the amount of the additive Ag. Judging from the overall results, it is preferable that the amount of the additive Ag is between 2 and 20 atomic %.

### (Experiment 2)

In Experiment 2, the relationship between the saturation magnetization Ms and the film thickness was measured for magnetic thin films that have the same composition as the magnetic thin film in Experiment 1. The magnetic thin films were annealed at different temperatures, and the amount of the additive Ag was 10 atomic % or 15 atomic %.

Table 4 shows the results when the amount of the additive Ag was 10 atomic %. FIG. 7 shows a graph showing the relationship between the film thickness and the saturation magnetization Ms when the amount of the additive Ag was 10 atomic %.

TABLE 4
(Amount of additive Ag: 15 atomic %)

| | Saturation magnetization (×10³ A/m) | | |
|---|---|---|---|
| | Annealing | Annealing | Annealing |
| Film thickness | temperature: | temperature: | temperature: |
| (nm) | 300° C. | 320° C. | 350° C. |
| 8 | 780 | 821 | 819 |
| 10 | 755 | 825 | 816 |
| 20 | 750 | 811 | 820 |
| 50 | 742 | 791 | 821 |
| 80 | 722 | 786 | 825 |

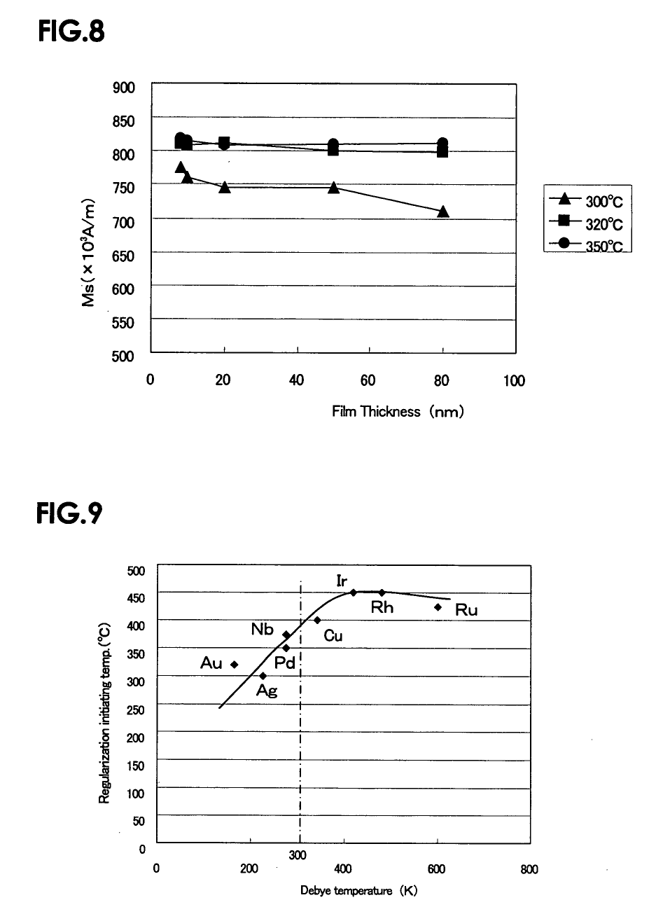

Table 5 shows the results when the amount of the additive Ag was 15 atomic %. FIG. 8 shows a graph showing the relationship between the film thickness and the saturation magnetization Ms when the amount of the additive Ag was 15 atomic %.

TABLE 5
(Amount of additive Ag: 15 atomic %)

| | Saturation magnetization (×10³ A/m) | | |
|---|---|---|---|
| | Annealing | Annealing | Annealing |
| Film thickness | temperature: | temperature: | temperature: |
| (nm) | 300° C. | 320° C. | 350° C. |
| 8 | 775 | 810 | 818 |
| 10 | 760 | 809 | 815 |
| 20 | 746 | 812 | 809 |
| 50 | 746 | 801 | 810 |
| 80 | 710 | 799 | 812 |

It can be understood from the results of Experiment 2 that approximately the same results were obtained for the case in which the amount of the additive Ag was 10 atomic % and for the case in which the amount of the additive Ag was 15 atomic %. In both cases, the saturation magnetization Ms was approximately constant regardless of the film thickness when the annealing temperature was 350° C. The inventors think that, considering the results of Experiment 1, this is because the magnetic thin film was completely regularized when the annealing temperature was 350° C. and when the amount of the additive Ag was between 10 and 15 atomic %. Further, the saturation magnetization Ms was at an approximately same level regardless of the film thickness when the annealing temperature was 300° C. or 320° C., although the saturation magnetization Ms is apt to be decreased in accordance with the increase in film thickness. When magnetic thin film is used for an MR element, there will be no practical problems because the film thickness for a practical use is approximately 10 nm.

### (Experiment 3)

In Experiment 3, the relationship between the Debye temperature and the regularization initiating temperature was evaluated by forming alloy layers on substrates and by regularizing the alloy layers through annealing. Alloy layers contain a base material having the same composition as the material in Experiment 1 and having an additive element which has the Debye temperature that is different in each alloy layer. The amount of the additive element was 10 atomic % relative to the base material. For purposes of comparison, a magnetic thin film without an additive element was also produced, and the regularization initiating temperature thereof was measured. The film thickness of the produced magnetic thin film was 80 nm. The regularization initiating temperature was defined as the temperature at which the saturation magnetization Ms was obtained. The inventors think that the conditions regarding the amount of the additive element and regarding the thickness of the magnetic thin film in Experiment 3 are appropriate for evaluating the regularization initiating temperature, judging from the test results of Experiments 1 and 2 regarding the amount of the additive elements and the film thickness.

Table 6 shows the additive elements that were added, the Debye temperatures thereof, and the regularization initiating temperatures. FIG. 9 shows a graph showing the relationship between the Debye temperature of the additive element and the regularization initiating temperature.

TABLE 6

| | | |
|---|---|---|
| | | Regularization |
| Additive | Debye temperature | initiating temperature |

| element | (K) | (° C.) | (° C.) |
|---|---|---|---|
| Au | 165 | −108 | 320 |
| Ag | 225 | −48 | 300 |
| Pd | 274 | 1 | 350 |
| Nb | 275 | 2 | 375 |
| Cu | 343 | 70 | 400 |
| Ir | 420 | 147 | 450 |
| Rh | 480 | 207 | 450 |
| Ru | 600 | 327 | 425 |
| None | — | — | 400 |

It can be understood from the results of Experiment 3 that the regularization initiating temperature can be lowered, compared with a case in which an additive element is not added, by adding an element having the Debye temperature that is equal to or less than 300K, such as Au, Ag, Pd, or Nb. However, the regularization initiating temperature will be increased, compared with a case in which an additive element is not added, if an element having a relatively high Debye temperature, such as 400 K or more, is added.

Table 7 shows examples of elements that can be used as the additive element, together with the Debye temperatures thereof.

TABLE 7

| Element | Debye temperature (K) | Element | Debye temperature (K) |
|---|---|---|---|
| As | 282 | Sb | 211 |
| Se | 90 | Hf | 252 |
| Y | 280 | Ta | 240 |
| Zr | 291 | Pt | 240 |
| Nb | 275 | Au | 165 |
| Pd | 274 | Hg | 71.9 |
| Ag | 225 | Tl | 78.5 |
| Cd | 209 | Pb | 105 |
| In | 108 | Bi | 119 |
| Sn | 200 | La | 142 |

The Debye temperatures shown in Table 7, which were cited from a database at the website (http://www.nims.go.jp/jpn/) of the National Institute for Materials Science, were obtained through band calculations in accordance with the FLAPW (Full-potential Linear Augmented Plane-Wave) method.

Some of the elements which are shown in Table 7 (As, Sb, Bi, In, and Pb) may also be contained in the Z site of the Heusler alloy which does not contain an additive element. If the Heusler alloy contains any one of these elements before an additive element is added, the additive element will be selected from the group of elements in which these elements are excluded.

In addition, although only one element was added as the additive element in Experiments 1 to 3, the same effect, i.e., low temperature for regularization, can also be achieved when two or more elements are added, as long as the Debye temperatures of the two or more elements are equal to or less than 300K.

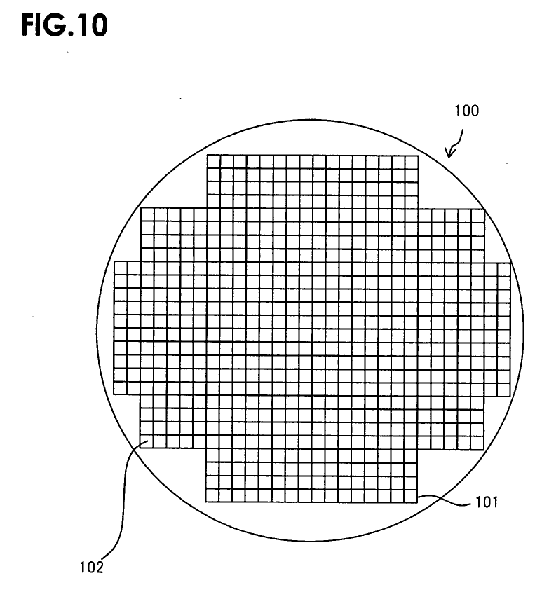

A plurality of the thin-film magnetic heads according to the present invention are formed on a wafer. FIG. 10 is a conceptual plan view of a wafer on which a plurality of structures, each including the thin-film magnetic head illustrated in FIG. 1, are formed.

Wafer 100 has a plurality of head element assemblies 101. Each head element assembly 101 includes a plurality of head elements 102, and serves as a working unit when air bearing surface S of thin-film magnetic head 1 (see FIG. 1) is polished. Dicing zones, not shown, are provided between head element assemblies 101, as well as between head elements 102. Head element 102, which is a structure that includes thin film magnetic head 1, is processed to become thin-film magnetic head 1 after going through required processes, such as a polishing process to form air bearing surface S. In general, the polishing process is performed on a plurality of head elements 102 that are diced in a row.

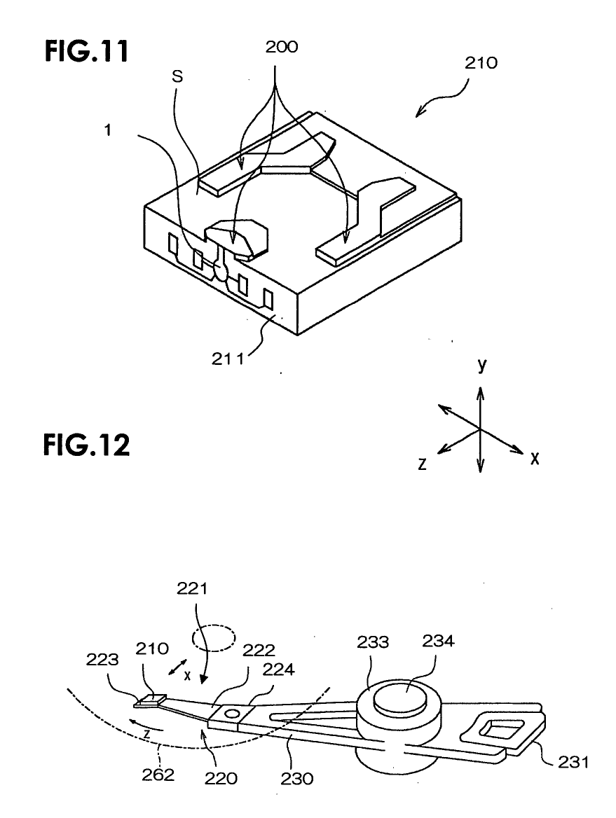

Explanation next regards a head gimbal assembly and a hard disk drive that uses the thin-film magnetic head. Referring to FIG. 11, slider 210 which is included in the head gimbal assembly will be described first. In a hard disk drive, slider 210 is a stacked layer assembly that is arranged opposite to a hard disk, which is a rotationally-driven disciform storage medium. Slider 210 has a substantially hexahedral form, and air bearing surface 200 is formed thereon. One of the six surfaces of slider 210 forms ABS, which is positioned opposite to the hard disk. When the hard disk rotates in the z direction shown in FIG. 11, an airflow which passes between the hard disk and slider 210 creates a dynamic lift which is applied to slider 210 downward in the y direction of FIG. 11. Slider 210 is configured to lift up from the surface of the hard disk with this dynamic lift effect. In addition, the x direction in FIG. 11 is equal to the track-transverse direction of a hard disk. On face 211 of slider 210 from which air flows out, electrode pads for signal input/signal output for read head portion 2 and write head portion 3 (refer to FIG. 1) are formed. Face 211 corresponds to the top surface in FIG. 1.

Referring to FIG. 12, head gimbal assembly 220 that has the thin-film magnetic head will be explained next. Head gimbal assembly 220 is provided with slider 210, and suspension 221 for resiliently supporting slider 210. Suspension 221 has; load beam 222 in the shape of a flat spring and made of, for example, stainless steel; flexure 223 attached to one end of load beam 222, and to which slider 210 is fixed, while providing an appropriate degree of freedom to slider 210; and base plate 224 provided on the other end of load beam 222. The portion of flexure 223 to which slider 210 is attached has a gimbal section for maintaining slider 210 in a fixed orientation.

The arrangement in which head gimbal assembly 220 is attached to a single arm 230 is called a head arm assembly. Arm 230 moves slider 210 in the transverse direction x with regard to the track of hard disk 262. One end of arm 230 is attached to base plate 224. Coil 231, which constitutes a part of the voice coil motor, is attached to the other end of arm 230. In the intermediate portion of arm 230, bearing section 233 which has shaft 234 to rotatably hold arm 230 is provided. Arm 230 and the voice coil motor to drive arm 230 constitutes an actuator.

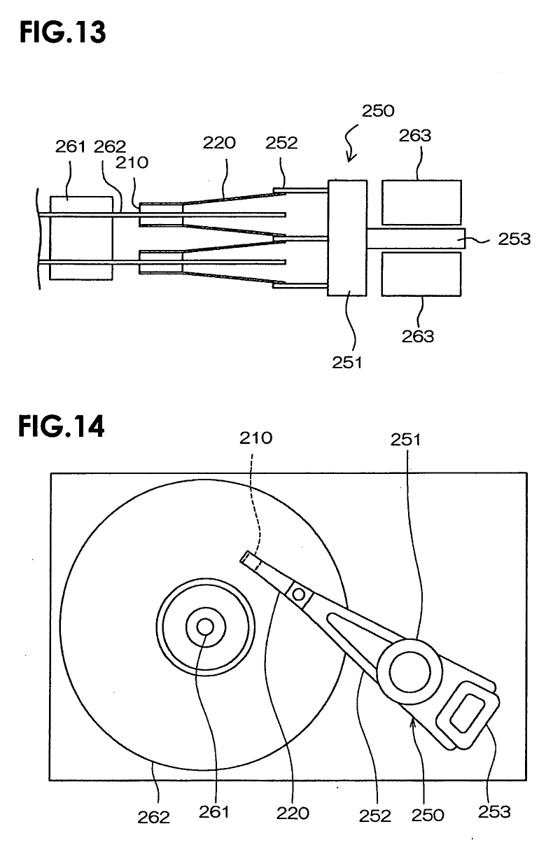

Referring to FIG. 13 and FIG. 14, a head stack assembly and a hard disk drive that use the thin-film magnetic head as a head element will be explained next. The arrangement in which a head gimbal assembly 220 is attached to the respective arm of a carriage having a plurality of arms is called a head stack assembly. FIG. 13 is an explanatory diagram illustrating an essential part of a hard disk drive, and FIG. 14 is a plan view of the hard disk drive. Head stack assembly 250 has carriage 251 provided with a plurality of arms 252. A plurality of head gimbal assemblies 220 are attached to a plurality of arms 252 such that head gimbal assemblies 220 are arranged apart from each other in the vertical direction. Coil 253, which constitutes a part of the voice coil, is attached to carriage 251 on the side opposite to arms 252. The voice coil motor has permanent magnets 263 which are arranged in positions opposite to each other interposing coil 253 of head stack assembly 250 therebetween.

Referring to FIG. 13, head stack assembly 250 is installed in the hard disk drive. The hard disk drive has a plurality of hard disks connected to spindle motor 261. Two sliders 210 are arranged per each hard disk 262 at positions opposite to each other interposing hard disk 262 therebetween. Head stack assembly 250 and the actuator, except for sliders 210, work as a positioning device. They carry sliders 210 and work to position sliders 210 relative to hard disks 262. Sliders 210 are moved by the actuator in the transverse direction with regard to the tracks of hard disks 262, and positioned relative to hard disks 262. Thin-film magnetic head 1 that is contained in slider 210 records information to hard disk 262 with a write head, and reads information recorded in hard disk 262 with a read head.

In addition, the thin-film magnetic head is not limited to the embodiment described above, and various modifications can be possible. For example, in the foregoing embodiment, explanations have been made for a thin-film magnetic head having a MR element which is formed on a substrate, and an inductive electromagnetic converting element for writing is disposed thereon. However, the order of stacking may be reversed. Additionally, in the foregoing embodiment, the thin-film magnetic head is provided with both an MR element and an inductive electromagnetic converting element. However, the thin-film magnetic head may only be provided with an MR element.

The magnetic thin film and the thin-film magnetic head that utilizes the magnetic thin film can also be applied to a magnetic memory element and a magnetic sensor assembly. A magnetic memory element has a plurality of the above-described magnetoresistance elements and a wiring unit which is connected to the plurality of magnetoresistance elements. The wiring unit is adapted to selectively write information in any one of the magnetoresistance elements or to selectively read information from any one of the magnetoresistance elements. A magnetic sensor assembly has a substrate on which the above-described magnetoresistance element is provided, and a lead which is connected to the magnetoresistance element. The lead is adapted to output magnetic information about an external magnetic field which is detected by the magnetoresistance element.

Although a certain preferred embodiment of the present invention has been shown and described in detail, it should be understood that various changes and modifications may be made without departing from the spirit or scope of the appended claims.

What is claimed is:

1. A magnetic thin film comprising:
a layer which is formed of an alloy having a ordered crystal structure whose composition formula is represented by XYZ or X₂YZ (where X is one or more than one of the elements selected from the group consisting of Co, Ir, Rh, Pt, and Cu, Y is one or more than one of the elements selected from the group consisting of V, Cr, Mn, and Fe, and Z is one or more than one of the elements selected the group consisting of Al, Si, Ge, As, Sb, Bi, In, Ti, and Pb),
wherein said alloy contains at least one additive element which is not included in the composition formula of said alloy and which has a Debye temperature that is equal to or less than 300K.

2. The magnetic thin film according to claim 1, wherein an amount of said additive element is between 2 to 20 atomic % relative to said alloy.

3. The magnetic thin film according to claim 1, wherein said additive element is selected from the group consisting of As, Se, Y, Zr, Nb, Pd, Ag, Cd, In, Sn, Sb, Hf, Ta, Pt, Au, Hg, TI, Pb, Bi, and La.

4. The magnetic thin film according to claim 3, wherein said additive element is selected from the group consisting of Au, Ag, Pd, and Nb.

5. The magnetic thin film according to claim 1, wherein said crystal structure has a L21 structure, said structure indicating a preferential orientation of (220) plane, and having a lattice constant between 0.55 and 0.58 nm.

6. The magnetic thin film according to claim 1, wherein said crystal structure has a B2 structure, said structure indicating a preferential orientation of (110) plane, and having a lattice constant between 0.275 and 0.29 nm.

7. A magnetoresistance element comprising:
a pinned layer whose magnetization direction is fixed;
a free layer whose magnetization direction changes in accordance with an external magnetic field; and
a non-magnetic spacer layer which is provided between said pinned layer and said free layer,
wherein both of said pinned layer and said free layer, said pinned layer, or said free layer includes said magnetic thin film according to claim 1.

8. The magnetoresistance element according to claim 7, wherein said pinned layer has two ferromagnetic layers and a non-magnetic intermediate layer which is sandwiched therebetween.

9. A thin-film magnetic head comprising said magnetoresistance element according to claim 7.

10. A magnetic memory element comprising:
a plurality of said magnetoresistance elements according to claim 7; and
a wiring unit which is connected to said plurality of magnetoresistance elements, said wiring unit being adapted to selectively write information in any one of said magnetoresistance elements or to selectively read information from any one of said magnetoresistance elements.
